(19) United States
(12) Patent Application Publication
(10) Pub. No.: US 2016/0196296 A1
(43) Pub. Date: Jul. 7, 2016

(54) METHODS AND APPARATUS FOR DELETING A PLURALITY OF DOCUMENTS ASSOCIATED WITH AN ELECTRONIC DOCUMENT REVIEW APPLICATION

(71) Applicant: kCura LLC, Chicago, IL (US)

(72) Inventors: David Bireta, Evanston, IL (US); Marc Zider, Lindenhurst, IL (US); Casey Bubert, Chicago, IL (US); Charlie Connor, Chicago, IL (US)

(73) Assignee: kCura CORPORATION, Chicago, IL (US)

(21) Appl. No.: 14/588,781

(22) Filed: Jan. 2, 2015

(51) Int. Cl. G06F 17/30

(52) U.S. Cl. CPC G06F 17/30371; G06F 17/30528; G06F 17/30011; G06F 17/30867

(57) ABSTRACT

Methods and apparatus for deleting a plurality of documents associated with an electronic document review application are disclosed. For example, a user may specify a subset of documents that the user would like to review in an electronic document review application. The system executes a query to construct a document container that lists the plurality of documents and automatically downloads the documents and associated metadata to the portable electronic device. The system then periodically compares a current time associated with a local clock of the portable electronic device with an expiration time to determine a comparison result (e.g., is a certain document container more than 30 days old?). The system automatically deletes the document container and any of the plurality of documents that were downloaded to the portable electronic device when the comparison result is indicative of the plurality of documents expiring.

The present disclosure relates in general to databases, and, in particular, to methods and apparatus for deleting a plurality of documents associated with an electronic document review application.

### BACKGROUND

The vast majority of documents we create and/or archive are stored electronically. In order to quickly find certain documents, the relevant data from these documents is typically extracted, catalogued, and organized in a centralized database to make them searchable. Once the documents are in the database, certain documents are typically annotated. For example, in a lawsuit, certain portions of some documents may be highlighted and or commented on by a reviewer. In some circumstances, these databases can be very large. For example, a law suit may involve millions of documents. Reviewing documents in these large databases can be problematic.

Typically, users review and annotate the documents on a computing device while the computing device is connected to the database via a network connection. For example, the user may view a document using a desktop computing device and redact a certain portion of text. Subsequently, the user's annotations are stored back to the central database. In this manner, other users can also see the annotations.

Often, users work on portable computing devices that are sometimes not connected to a network. For example, an attorney may want to review and annotate documents during a flight using a tablet device. However, doing so suffers from several drawbacks. First, due to memory limitations of the portable computing device, the entire database and associated documents typically cannot be copied to the portable computing device. As a result, the user is forced to find a subset of documents and manually move them over to the portable electronic device.

Subsequently, if these documents are not manually removed from the portable electronic device, the device memory may become full. Additionally, the “stale” documents that remain on a tablet device pose increasing security risks the longer they remain on the device.

### BRIEF DESCRIPTION OF THE DRAWINGS

FIG. 1 is a block diagram of an example network communication system.

FIG. 2 is a block diagram of an example computing device.

FIG. 3 is a flowchart of an example process for deleting a plurality of documents associated with an electronic document review application.

FIG. 4 is a screen shot of an example electronic document review application.

FIG. 5 is another screen shot of an example electronic document review application.

### DETAILED DESCRIPTION OF THE PREFERRED EMBODIMENTS

Briefly, methods and apparatus for deleting a plurality of documents associated with an electronic document review application are disclosed. For example, a user may specify a subset of documents that the user would like to review in an electronic document review application. The system executes a query to construct a document container that lists the plurality of documents and automatically downloads the documents and associated metadata to the portable electronic device. The system then periodically compares a current time associated with a local clock of the portable electronic device with an expiration time to determine a comparison result (e.g., is a certain document container more than 30 days old?). The system automatically deletes the document container and any of the plurality of documents that were downloaded to the portable electronic device when the comparison result is indicative of the plurality of documents expiring.

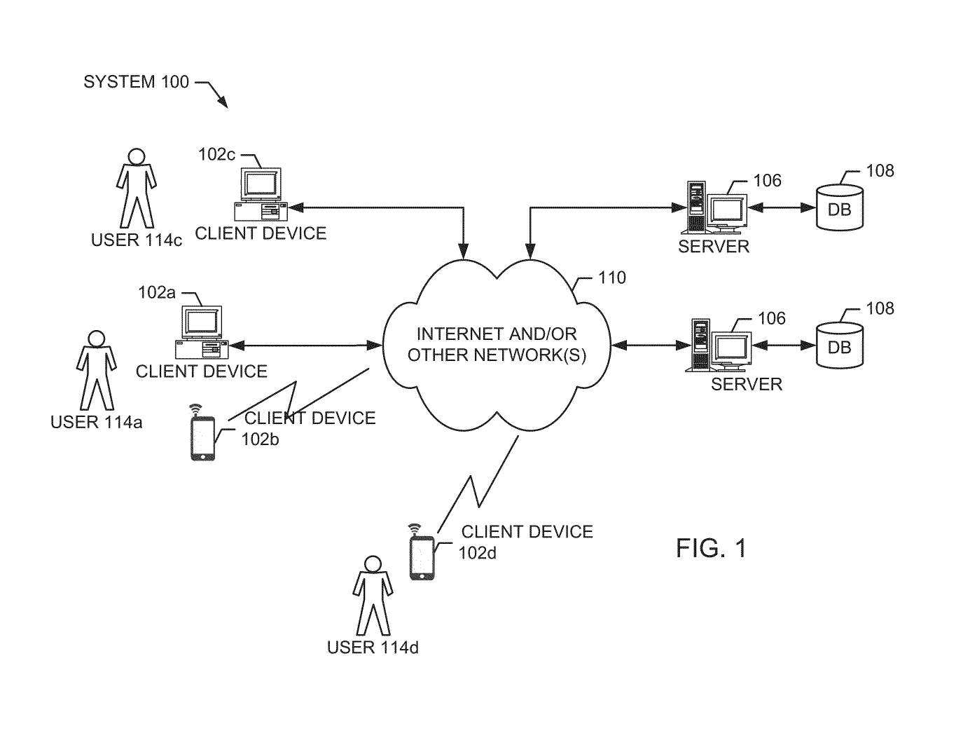

Turning now to the figures, the present system is most readily realized in a network communication system 100. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

In this example, user 114a is using client device 102a and client device 102b. For example, user 114a may be reviewing documents displayed on a desktop display of client device 102a and coding those documents using a touch screen on client device 102b.

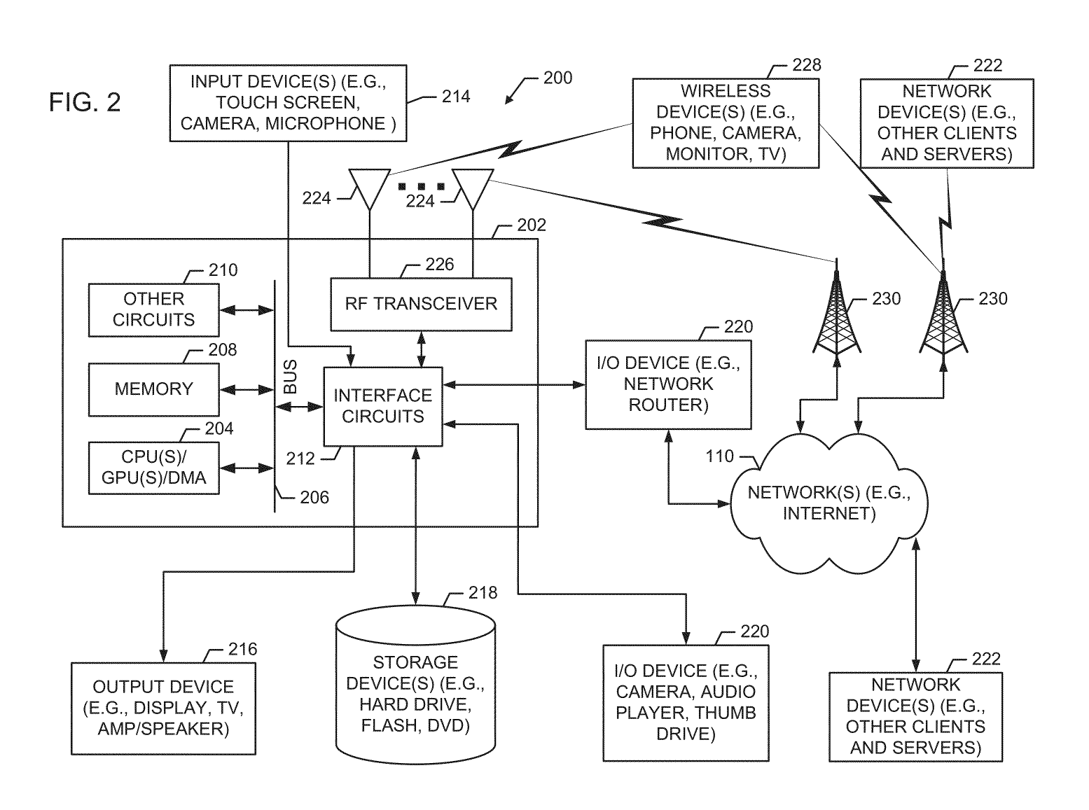

Each of the devices illustrated in FIG. 1 (e.g., clients 102 and/or servers 106) may include certain common aspects of many computing devices such as microprocessors, memories, input devices, output devices, etc. FIG. 2 is a block diagram of an example computing device. The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, camera, voice recognition system, accelerometer, global positioning system (GPS), and/or any other suitable input device.

One or more displays, printers, speakers, monitors, televisions, high definition televisions, and/or other suitable output devices 216 may also be connected to the main unit 202 via the interface circuit 212. One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200. The computing device 200 may also exchange data with one or more input/output (I/O) devices 220, such as network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

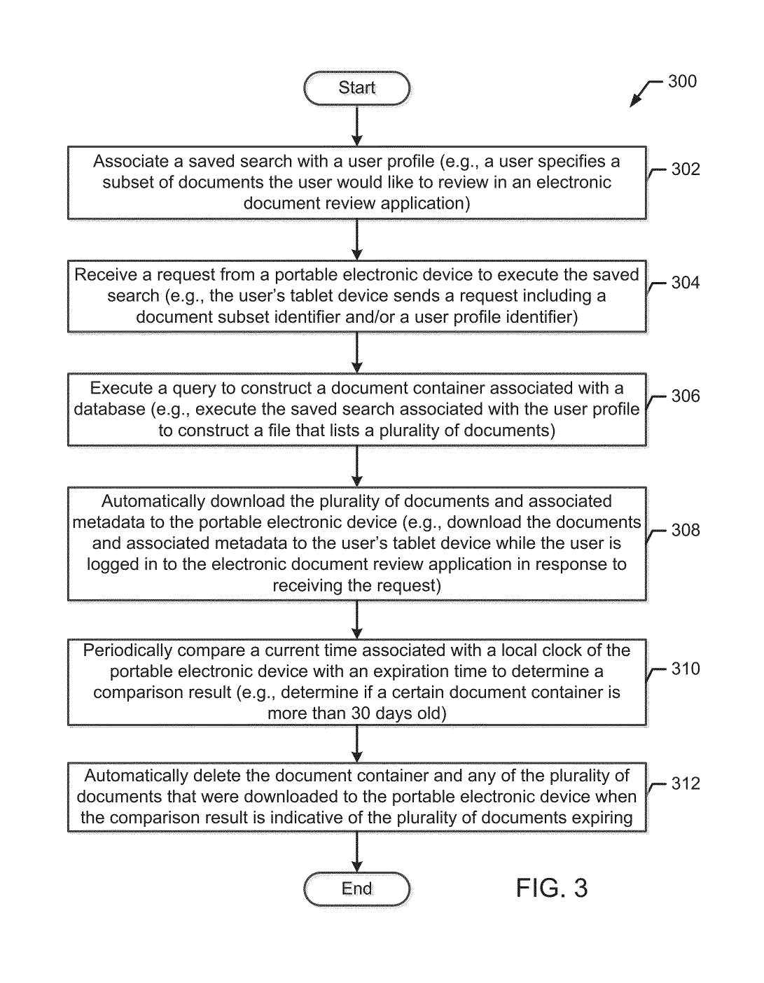

FIG. 3 is a flowchart of an example process for deleting a plurality of documents associated with an electronic document review application. The process 300 may be carried out by one or more suitably programmed processors, such as a CPU executing software (e.g., block 204 of FIG. 2). The process 300 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 300 is described with reference to the flowchart illustrated in FIG. 3, it will be appreciated that many other methods of performing the acts associated with process 300 may be used. For example, the order of many of the operations may be changed, and some of the operations described may be optional.

In general, methods and apparatus for deleting a plurality of documents associated with an electronic document review application are disclosed. For example, a user may specify a subset of documents that the user would like to review in an electronic document review application. The system executes a query to construct a document container that lists the plurality of documents and automatically downloads the documents and associated metadata to the portable electronic device. The system then periodically compares a current time associated with a local clock of the portable electronic device with an expiration time to determine a comparison result (e.g., is a certain document container more than 30 days old?). The system automatically deletes the document container and any of the plurality of documents that were downloaded to the portable electronic device when the comparison result is indicative of the plurality of documents expiring.

More specifically, in this example, the process 300 begins when a user 114 associates a saved search with a user profile (block 302). For example, a user 114 may specify a subset of documents that the user would like to review in an electronic document review application. The system then receives a request from a portable electronic device to execute the saved search (block 304). For example, a user's tablet device may send a request including a document subset identifier and/or a user profile identifier.

The system then executes a query to construct a document container associated with a database (block 306). For example, the system may execute the saved search associated with the user profile to construct a file that lists a plurality of documents. The system then automatically downloads the plurality of documents and associated metadata to the portable electronic device (block 308). For example, the system may download the documents and associated metadata to the user's tablet device while the user is logged in to the electronic document review application in response to receiving the request.

The system then periodically compares a current time associated with a local clock of the portable electronic device with an expiration time to determine a comparison result (block 310). For example, the system may determine if a certain document container is more than 30 days old. Preferably, the system adjusts for any time zone changes. For example, if the document was sent to a time zone that is one hour later, one hour may be added to the total expiration time, unless the document is moved back to the earlier time zone.

The system then automatically deletes the document container and any of the plurality of documents that were downloaded to the portable electronic device when the comparison result is indicative of the plurality of documents expiring (block 312). In addition, the system may automatically delete the document container and any of the plurality of documents that were downloaded to the portable electronic device based on an event from an operating system indicative of the local clock of the portable electronic device being adjusted by more than a predetermined threshold.

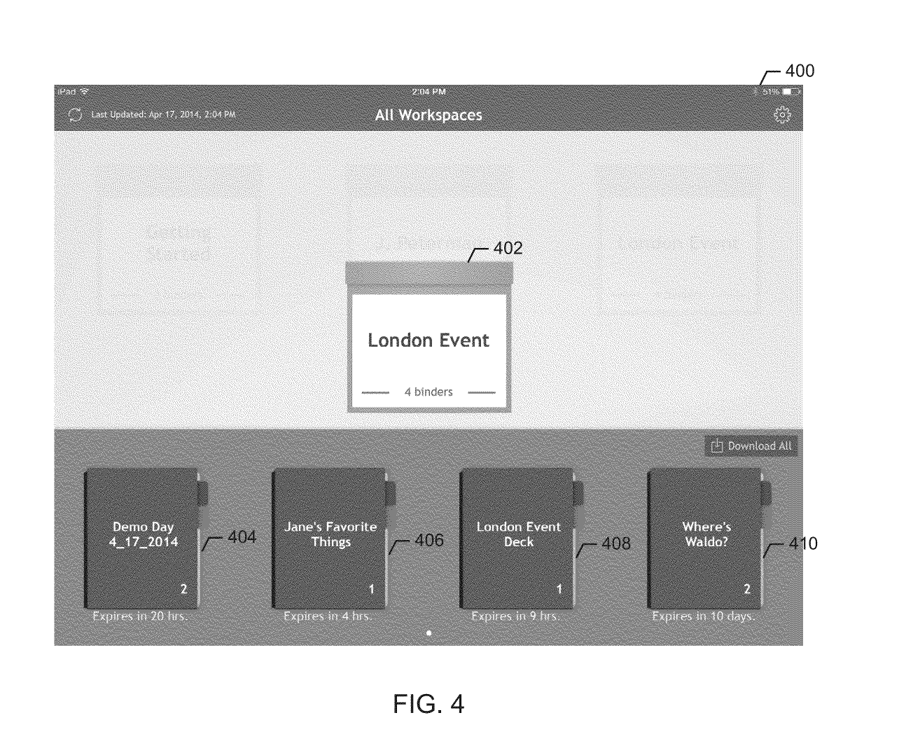

FIG. 4 is a screen shot 400 of an example electronic document review application. In this example, a user 114 is viewing a project 402 called “London Event.” This example project includes four document containers. More specifically, the “London Event” project 402 includes a “Demo Day 4_17_2014” document container 404, a “Jane's Favorites Things” document container 406, a “London Event Deck” document container 408, and a “Where's Waldo?” document container 410. The “Demo Day 4_17_2014” document container 404 includes 2 documents and expires in 20 hours. The “Jane's Favorites Things” document container 406 includes 1 document and expires in 4 hours. The “London Event Deck” document container 408 includes 1 document and expires in 9 hours. The “Where's Waldo?” document container 410 includes 2 documents and expires in 10 days.

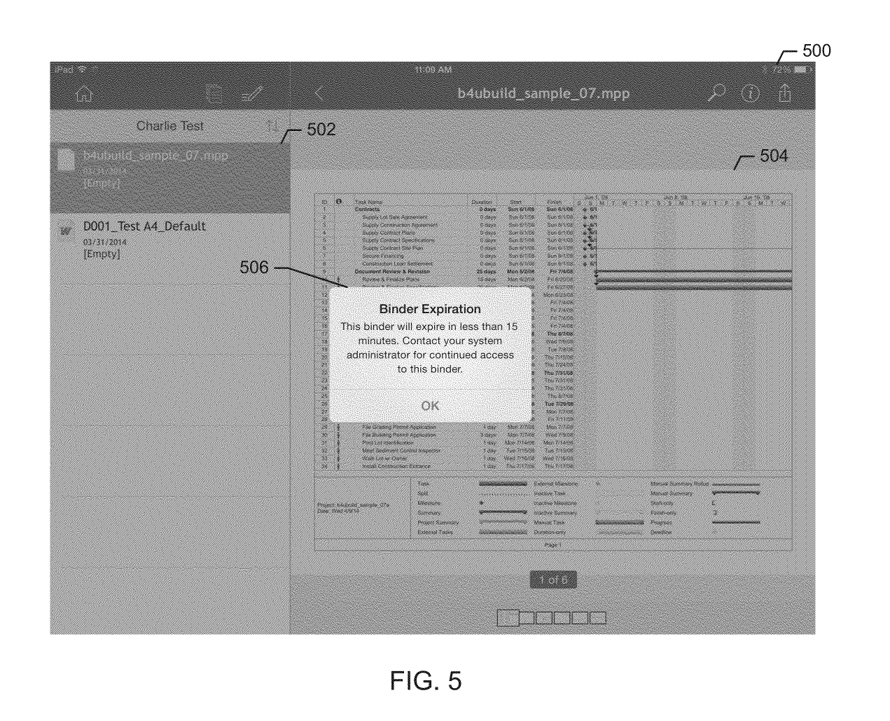

FIG. 5 is another screen shot of an example electronic document review application. In this example, a user 114 has selected 502 a document 504 for viewing, and the document review application has generated a message 506 indicating that the document will expire in less than 15 minutes. The example message 506 also instructs the user 114 to contact a system administrator for continued access to this document container.

In summary, persons of ordinary skill in the art will readily appreciate that methods and apparatus for deleting a plurality of documents associated with an electronic document review application have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of deleting a plurality of documents associated with an electronic document review application, the method comprising:
executing a query to construct a document container, the document container being indicative of the plurality of documents associated with the electronic document review application;
periodically comparing a current time associated with a local clock of the portable electronic device with an expiration time to determine a comparison result; and
automatically deleting the document container when the comparison result is indicative of the plurality of documents expiring.

2. The method of claim 1, further comprising downloading the plurality of documents and associated metadata to a portable electronic device based on the document container.

3. The method of claim 2, wherein automatically deleting the document container includes automatically deleting the plurality of documents and associated metadata.

4. The method of claim 1, wherein if the local clock of the portable electronic device is adjusted by more than a predetermined threshold, automatically deleting the plurality of documents.

5. The method of claim 4, wherein automatically deleting the plurality of documents is in response to an event from an operating system indicative of the local clock of the portable electronic device being adjusted by more than the predetermined threshold.

6. The method of claim 1, further comprising facilitating selection of the expiration time via a user interface.

7. The method of claim 1, further comprising downloading the expiration time to the portable electronic device.

8. The method of claim 1, further comprising displaying a timer in a user interface indicative of an amount of time until the plurality of documents expire.

9. The method of claim 1, further comprising assigning a subset identifier to the plurality of documents and associating the subset identifier with a user profile.

10. The method of claim 1, further comprising assigning a subset identifier to the plurality of documents and associating the subset identifier with a device identifier of the portable electronic device.

11. The method of claim 1, wherein executing the query to retrieve the plurality of documents includes executing a saved search associated with a user profile.

12. The method of claim 1, wherein executing the query to retrieve the plurality of documents is in response to receiving a request from the portable electronic device, the request including the subset identifier.

13. The method of claim 1, wherein executing the query to retrieve the plurality of documents is performed by an electronic document review application.

14. The method of claim 1, wherein periodically comparing a current time associated with a local clock of the portable electronic device with an expiration time includes compensation for a time zone change.

15. An apparatus for deleting a plurality of documents associated with an electronic document review application, the apparatus comprising:
a processor;
a network interface operatively coupled to the processor; and
a memory device operatively coupled to the processor, the memory device storing instructions to cause the processor to:
execute a query to construct a document container, the document container being indicative of a plurality of documents associated with the electronic document review application;
periodically compare a current time associated with a local clock of the portable electronic device with an expiration time to determine a comparison result; and
automatically delete the document container when the comparison result is indicative of the plurality of documents expiring.

16. The apparatus of claim 15, wherein the instructions are structured to cause the processor to download the plurality of documents and associated metadata to a portable electronic device based on the document container.

17. The apparatus of claim 16, wherein automatically deleting the document container includes automatically deleting the plurality of documents and associated metadata.

18. The apparatus of claim 15, wherein if the local clock of the portable electronic device is adjusted by more than a predetermined threshold, automatically deleting the plurality of documents.

19. The apparatus of claim 18, wherein automatically deleting the plurality of documents is in response to an event from an operating system indicative of the local clock of the portable electronic device being adjusted by more than the predetermined threshold.

20. The apparatus of claim 15, wherein the instructions are structured to cause the processor to facilitate selection of the expiration time via a user interface.

21. The apparatus of claim 15, wherein the instructions are structured to cause the processor to download the expiration time to the portable electronic device.

22. The apparatus of claim 15, wherein the instructions are structured to cause the processor to display a timer in a user interface indicative of an amount of time until the plurality of documents expire.

23. The apparatus of claim 15, wherein the instructions are structured to cause the processor to assign a subset identifier to the plurality of documents and associate the subset identifier with a user profile.

24. The apparatus of claim 23, wherein executing the query to retrieve the plurality of documents is in response to receiving a request from the portable electronic device, the request including the subset identifier.

25. The apparatus of claim 15, wherein executing the query to retrieve the plurality of documents is performed by an electronic document review application.

26. The apparatus of claim 15, wherein periodically comparing a current time associated with a local clock of the portable electronic device with an expiration time includes compensation for a time zone change.

27. A non-transitory computer readable medium storing instructions structured to cause a computing device to:
execute a query to construct a document container, the document container being indicative of a plurality of documents associated with the electronic document review application;
periodically compare a current time associated with a local clock of the portable electronic device with an expiration time to determine a comparison result; and
automatically delete the document container when the comparison result is indicative of the plurality of documents expiring.

28. The non-transitory computer readable medium of claim 27, wherein the instructions are structured to cause the processor to download the plurality of documents and associated metadata to a portable electronic device based on the document container.

29. The non-transitory computer readable medium of claim 28, wherein automatically deleting the document container includes automatically deleting the plurality of documents and associated metadata.

30. The non-transitory computer readable medium of claim 27, wherein if the local clock of the portable electronic device is adjusted by more than a predetermined threshold, automatically deleting the plurality of documents.

31. The non-transitory computer readable medium of claim 30, wherein automatically deleting the plurality of documents is in response to an event from an operating system indicative of the local clock of the portable electronic device being adjusted by more than the predetermined threshold.

32. The non-transitory computer readable medium of claim 27, wherein the instructions are structured to cause the processor to facilitate selection of the expiration time via a user interface.

33. The non-transitory computer readable medium of claim 27, wherein the instructions are structured to cause the processor to download the expiration time to the portable electronic device.

34. The non-transitory computer readable medium of claim 27, wherein the instructions are structured to cause the processor to display a timer in a user interface indicative of an amount of time until the plurality of documents expire.

35. The non-transitory computer readable medium of claim 27, wherein the instructions are structured to cause the processor to assign a subset identifier to the plurality of documents and associate the subset identifier with a user profile.

36. The non-transitory computer readable medium of claim 35, wherein executing the query to retrieve the plurality of documents is in response to receiving a request from the portable electronic device, the request including the subset identifier.

37. The non-transitory computer readable medium of claim 27, wherein executing the query to retrieve the plurality of documents is performed by an electronic document review application.

38. The non-transitory computer readable medium of claim 27, wherein periodically comparing a current time associated with a local clock of the portable electronic device with an expiration time includes compensation for a time zone change.
